(19) United States
(12) Patent Application Publication
(10) Pub. No.: US 2014/0256165 A1
(43) Pub. Date: Sep. 11, 2014

(54) CONNECTOR

(71) Applicant: TELEBOX INDUSTRIES CORP., New Taipei City (TW)

(72) Inventors: Ray CHANG, New Taipei City (TW); Fu-Wen WU, Keelung City (TW); Chien-Ming TU, Keelung City (TW); Eric JENG, Taipei City (TW)

(73) Assignee: TELEBOX INDUSTRIES CORP., New Taipei City (TW)

(21) Appl. No.: 13/786,553

(22) Filed: Mar. 6, 2013

(51) Int. Cl. H01R 13/629

(52) U.S. Cl. CPC H01R 13/62983
USPC 439/153

(57) ABSTRACT

A connector includes a lower casing, a circuit board, a connecting head, multiple puncturing terminals, an upper casing and an upper lid. The lower casing includes a base and at least one support pole provided on the base. The base has an accommodating slot. The circuit board disposed in the accommodating slot. The connecting head is disposed on the base, and is electrically connected to the circuit board. The puncturing terminals are disposed on the circuit board. The upper casing includes a casing body, a cantilever structure extending from one side of the casing body and a cable holder located on the cantilever structure. The upper lid is disposed on the upper casing body. The upper lid has a release position and an open position relative to the casing body.

### TECHNICAL FIELD

The disclosure relates to a connector, more particularly to a connector having puncturing terminals.

### BACKGROUND

Along with the development of science technology, computers, televisions and other technology products have become essential to human life. Generally, users tend to connect several technology products in use. For example, users can connect a DVD (digital video disk) player to a 40′ LCD and a multichannel speaker system, to set up a home theater, thereby meeting the demands of users.

When connecting various technology products, users need connectors to connect these products electrically for a mutual signal transmission among them, so as to achieve an integration effect of various technology products. However, for conventional connectors, the connection strength between these connector and the cables is relatively low, thus the cables are prone to be detached from cables when influenced by an external force. In addition to causing a disconnection of the technology products, it may also result in breakdowns of them.

As a consequence, it is very important to design a connector to solve the problem that the cables are prone to detach from cables due to the insufficient connection strength of the cables and the connector.

### SUMMARY

In an embodiment, the disclosure provides a connector comprising a lower casing, a circuit board, a connecting head, a plurality of puncturing terminals, an upper casing and an upper lid. The lower casing comprises a base and at least one support pole provided on the base. The base has an accommodating slot. The circuit board is disposed in the accommodating slot. The connecting head is disposed on the base, and electrically connected to the circuit board. The puncturing terminals are disposed on the circuit board. The upper casing comprises a casing body, a cantilever structure extending from one side of the casing body and a cable holder located on the cantilever structure. The casing body is disposed on the base. The puncturing terminals puncturing the cantilever structure and is located on the cable holder. The cantilever structure has at least one cable groove corresponding to the cable holder. One bottom side of the groove faces the support pole. The upper lid is disposed on the upper casing body. The upper lid has a release position and an open position relative to the casing body. The upper lid is configured for moving from the open position to the fastening position, to push the cantilever structure to move towards the support pole, so as to reduce the distance from the bottom side of the cable groove to the support pole.

### BRIEF DESCRIPTION OF DRAWINGS

FIG. 1 is a perspective view for the connector according to one embodiment of this disclosure.

FIG. 2A is an exploded view of the connector in FIG. 1.

FIG. 2B is another exploded view of the connector in FIG. 1.

FIG. 3A is a sectional view of the connector in FIG. 1.

FIG. 3B is another sectional view of the connector in FIG. 1.

FIG. 4A is a sectional view of the connector and the cables in FIG. 1.

FIG. 4B is another sectional view of the connector and the cables in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

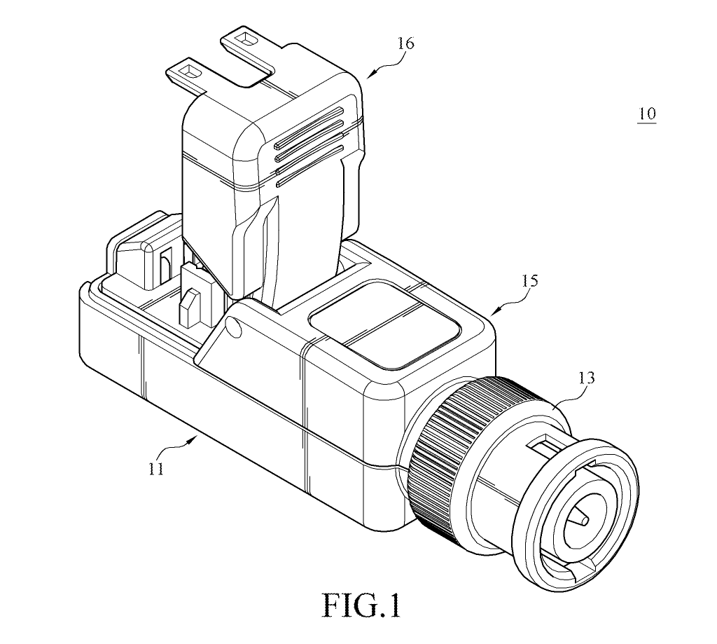

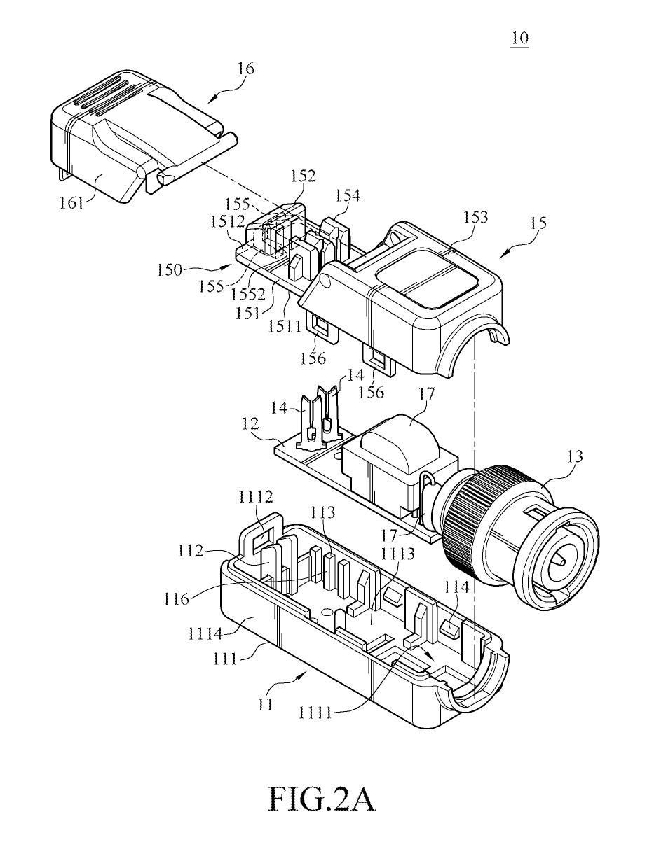

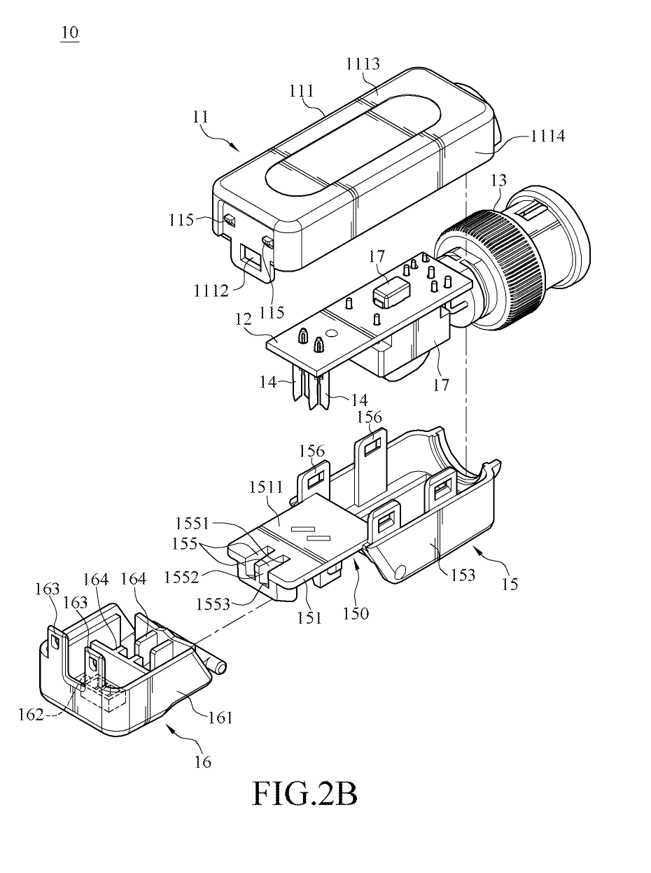

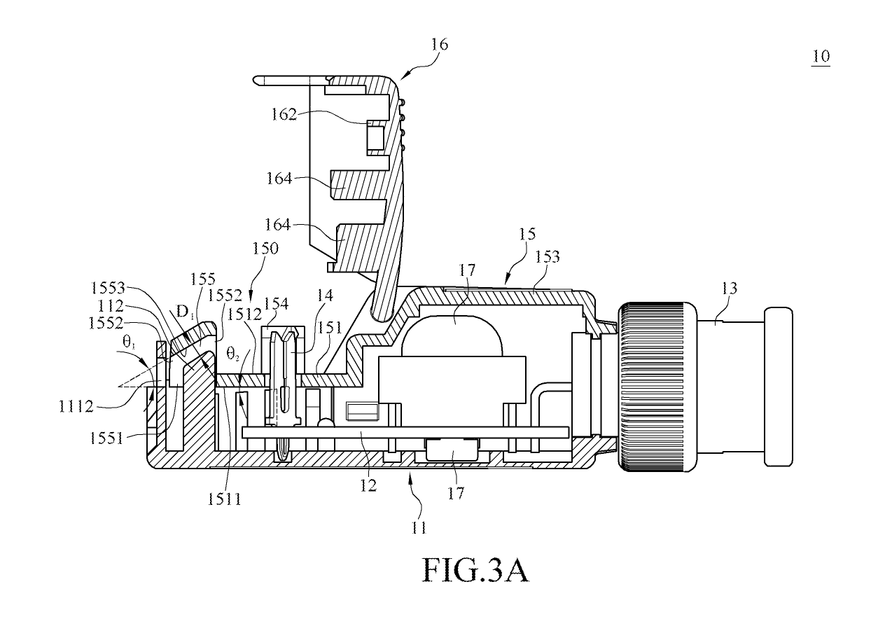

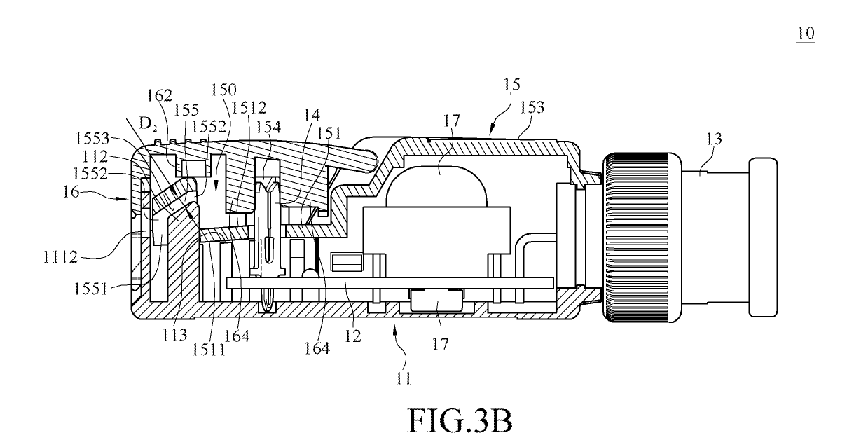

Firstly, please refer to FIG. 1 to FIG. 3A. FIG. 1 is a perspective view of the connector according to one embodiment of this disclosure; FIG. 2A is an exploded view of the connector in FIG. 1; FIG. 2B is another exploded view of the connector in FIG. 1; and FIG. 3A is a sectional view of the connector in FIG. 1. The connector 10 comprises a lower casing 11, a circuit board 12, a connecting head 13, a plurality of puncturing terminals 14, an upper casing 15 and an upper lid 16.

The lower casing 11 comprises a base 111, at least one support pole 112, a supporting surface 113, two first fastening elements 114 and two second fastening elements 115. In this embodiment, the number of support poles is two, but is not limited to this.

The base 111 has a base plate 1113 and a lateral plate 1114 connected to the base plate 1113, and further has an accommodating slot 1111, surrounded by the base plate 1113 and the lateral plate 1114. Additionally, the lateral plate 1114 of the base 111 is also provided with a hole 1112.

The support pole 112 is disposed on the base 111. There is a space between the two support poles 112, and the space is corresponding to the hole 1112.

In addition, the lower casing 11 further comprises a plurality of supporting ribs 116, disposed on the base plate 1113 of the base 111, and connected to the lateral plate 1114. Thus, supporting ribs 116 are configured for reinforcing the connection strength between the base plate 1113 and the lateral plate 1114. The end surfaces, away from the base plate 1113, of the supporting ribs 116 together form a supporting surface 113, tilted towards the support poles 112 for a second angle of θ2. In this embodiment, the second angle θ2 is from 1 to 7 degrees. In this embodiment and some other embodiments, the second angle θ2 is 4.2 degrees, but the dimension of the second angle θ2 should not be construed as a limitation of the disclosure.

The first fastening elements 114 are disposed on the lateral plate 1114 of the base 111, and are located at the side of the lateral plate 1114 facing the accommodating slot 1111. In this embodiment, the first fastening elements 114 are snaps, but are not limited to this. The second fastening elements 115 are disposed on the lateral plate 1114 of the base 111, and are located at the side of the lateral plate 1114 back to the accommodating slot 1111. In this embodiment, the second fastening elements 115 are snaps, but are not limited to this. However, the number of the first fastening elements 114 and the second fastening elements 115 are not construed as a limitation of the disclosure.

The circuit board 12 is disposed in the accommodating slot 1111.

The connecting heard 13 is disposed on the base 111, and is connected to the circuit board 12 electrically. The connecting head 13 is configured for accommodating another connector (not shown in drawings).

The puncturing terminals 14 are disposed on and electrically connected to the circuit board 12. The puncturing terminals 14 is configured for puncturing an external cable (not shown in drawings) provided on the connector 10, so that the external cable is electrically connected to the connector 10. In this embodiment, the number of puncturing terminals 14 is two, but is not limited to this. Users may adjust the number of puncturing terminals 14 depending on the requirements.

The upper casing 15 comprises a casing body 153, a cantilever structure 150, a cable holder 154 and a third fastening element 156.

The casing body 153 is disposed on the base 111, and the connecting head 13 is disposed between the casing body 153 and the base 111.

The cantilever structure 150 extends from one side of the casing body 153. Specifically, the cantilever structure 150 comprises a plate body 151, a projection 152 and a cable groove 155 running through the projection 152.

One side of the plate body 151 is connected to the casing body 153, and has a first surface 1511 and a second surface 1512 opposite to each other; wherein the first surface 1511 faces the lower casing 11. The projection 152 is located on the second surface 1512 of the plate body 151, and is corresponding to the support pole 112.

The cable groove 155 is a long narrow cut concave from the first surface 1511 towards the projection 152, and has a notch 1551 and two ports 1552 oppositely located. The notch 1551 is located on the side (i.e., the first surface 1511) of the projection 152, facing the lower casing 11, and is corresponding to the support pole 112. The ports 1552 are respectively located on two opposite sides of the projection 152. The notch 1551 communicates the ports 1552. The cable groove 155 is corresponding to the hole 1112. Specifically, part of the support pole 112 runs through the notch 1551 and is located in the cable groove 155, enabling a bottom side 1553 of the cable groove 155 to face and keep a distance from the support pole 112. There is a first angle θ1 between the bottom side 1553 and the first surface 1511. In this embodiment, the first angle θ1 is from 25 to 35 degrees. In this embodiment and some other embodiments, the first angle θ1 may be 30 degrees. However, the dimension of the first angle θ1 should not be construed as a limitation of the disclosure.

The cable holder 154 is disposed on the second surface 1512, and located between the casing body 153 and the projection 152. The cable holder 154 corresponds to the cable groove 155. In detail, the cable groove 155 is located between the hole 1112 and the cable holder 154. Further, the puncturing terminals 14 penetrate through the cantilever structure 150 and are located on the cable holder 154.

The third fastening element 156 is located on the casing body 153, and is corresponding to the first fastening element 114. In this embodiment, the third fastening element 156 is a fastening slot, but is not limited to this. Fastening of the first fastening element 114 and the third fastening element 156 enables the user to fix the upper casing 15 on the lower casing 11.

The upper lid 16 is disposed on the upper casing 15. The second surface 1512 of the plate body 11 faces toward the upper lid. Specifically, the upper lid is configured for pivoted on the casing body 153 of the upper casing 15. The upper lid 16 comprises a lid body 161, a push block 162, two fourth fastening elements 163 and at least one pushing rib 164. In this embodiment, the number of pushing ribs is two, but is not limited to this.

The lid body 161 is corresponding to the base 111, so that the cantilever structure 150 is located between the lid body 161 and the base 111. The push block 162 is disposed on the side of the lid body 161 facing the base 111. The push block 162 is corresponding to the projection 152. The fourth fastening elements 163 are located on the lid body 161, and corresponding to the second fastening element 115. In this embodiment, the fourth fastening elements 163 are a fastening slot, but the disclosure is not limited thereto. The pushing ribs 164 project from the side of the lid body 161 facing the base 111, and are corresponding to the projection 152 and the cable holder 154.

In this embodiment, the connector 10 also comprises at least one electronic component 17, disposed on and electrically connected to the circuit board 12. Assembling different electronic components 17 can provide users with connectors 10 with different functions, such as connectors with an image transfer function, connectors with a sound transmission function or connectors with a network transport function.

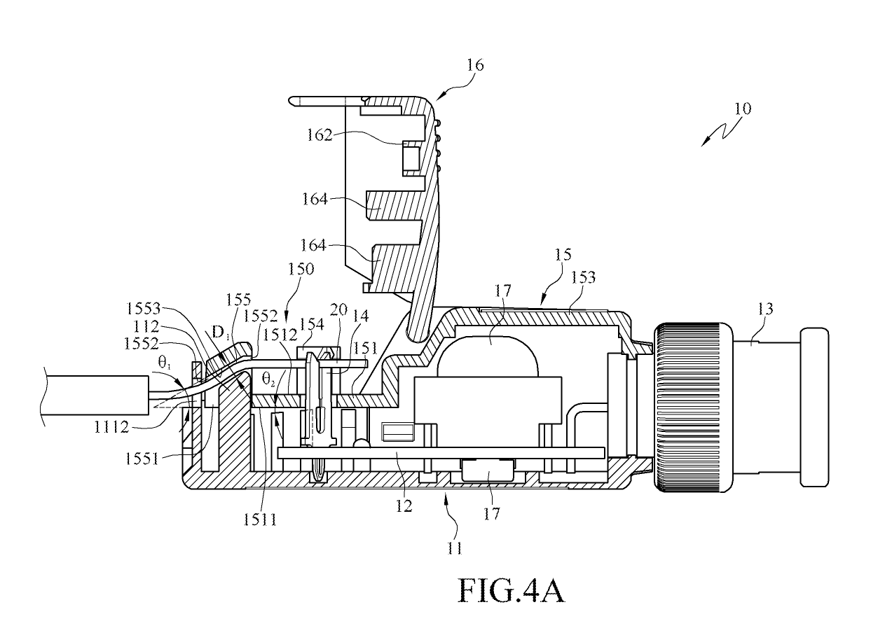

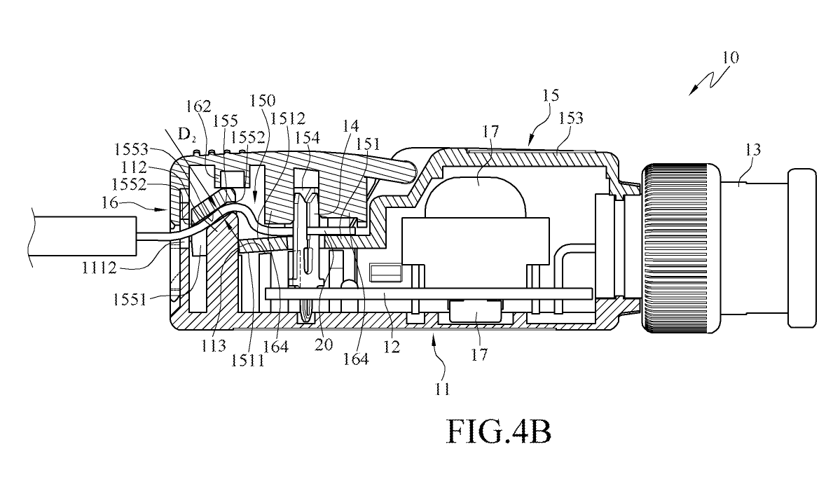

Then, please refer to FIG. 3A, FIG. 3B, FIG. 4A and FIG. 4B. FIG. 3B is another sectional view of the connector in FIG. 1. FIG. 4A is a sectional view of the connector and cables in FIG. 1. FIG. 4B is another sectional view of the connector and cables in FIG. 1. When releasing the fastening of the first fastening element 114 and the third fastening element 156, the user is able to make a pivot of the upper lid 16 toward the direction away from the lower casing 11, so that the upper lid 16 is located at an open position relative to the casing body 153 of the upper casing 15. When the upper lid 16 is at the open position, the cantilever structure 150 and partial puncturing terminals 14 are exposed from the connector 10. Thus, user is able to make a cable 20 penetrate through the hole 1112, the cable groove 155 and the cable holder 154 in sequential order, and place the cable 20 on the corresponding puncturing terminals 14 (as shown in FIG. 4A). Then, user is able to make a pivot of the upper lid 16 toward the direction close to the lower casing 11, so that a fastening is made between the first fastening element 114 and the third fastening element 156, and the upper lid is located at an open position relative to the casing body 153 of the upper casing 15. When the upper lid 16 moves from the open position to the fastening position, the pushing ribs 164 of the upper lid 16 will push the cable 20 to move toward the direction of the puncturing terminals 14, enabling that the cable is punctured by and then electrically connected to the puncturing terminals 14. Thereby the cable on the puncturing terminals 14 is fixed.

At this point, the push block 162 of the upper lid 16 pushes the cantilever structure 150 to be deformed, and thus move toward the support pole 112 and support against the supporting surface 113. In this way, the distance between the cable groove 155 and the bottom side 1553 is decreased from the first length Dl (as shown in FIG. 4A) to the second length D2 (as shown in FIG. 4B). Thus, the cable 20 is configured for being held between the bottom side 1553 of the cable groove 155 and the support pole 112, further enhancing the connection strength of the cable 20 and the connector 10.

In the embodiments of this disclosure, the cables are fixed on the puncturing terminals and held between the cable groove and the support pole. The first angle, meanwhile, is adjusted from 25 degrees to 35 degrees while the second angle is adjusted from 1 degree to 7 degrees. Thereby, the connection strength of the connector and the cable can be 1.5 kgw to 4.5 kgw. When the first angle is 30 degrees and the second is 4.2 degrees, the connection strength of the connector and the cable can be up to 4.5 kgw. Therefore, with the connector and the cable of this disclosure, the connection strength between them is certainly increased. The connection strength of the connector and the cable is relatively low and not easy to be used when the second angle is less than 1 degree. On the other hand, when the second angle is greater than 7 degrees, white marks and cracking are prone to occur to the cantilever structure 150 due to an excessive force applied on the cantilever structure, resulting in a decreased lifetime of connector.

Now, a test for the connection strength of the connector and the cable of this disclosure will be performed. Firstly, a set of 23 AWG (American Wire Gauge) solid wires, a set of 24 AWG solid wires and a set of 26 AWG stranded wires are provided. Each set is composed of two wires intertwined. Secondly, these wires are disposed and apply a force on the connector until the wires are broken away from the connector. When the wires are broken away from the connector, the applied force is the connection strength of the connector and the cable, ranging from 1.5 kgw to 4.5 kgw. That is, the connection strength is improved.

According to the connector disclosed in the embodiments of the disclosure, when moving from the open position to the fastening position, the pushing ribs of the upper lid will push the cantilever structure to move towards the support pole, then it can reduce the distance from the cable groove to its bottom side, thereby improving the cable holding strength from the cable groove and the bottom side, and increasing the connection force between the cable and the connector. Therefore, the problem that the cables are prone to detach from cables due to the insufficient connection strength of cables and connector can be solved.

What is claimed is:

1. A connector, comprising:
a lower casing comprising a base and at least one support pole provided on the base, wherein the base has an accommodating slot;
a circuit board disposed in the accommodating slot;
a connecting head disposed on the base, and electrically connected to the circuit board;
a plurality of puncturing terminals disposed on the circuit board;
an upper casing, comprising a casing body, a cantilever structure extending from one side of the casing body and a cable holder located on the cantilever structure, the casing body being disposed on the base, the puncturing terminals puncturing the cantilever structure and being located on the cable holder, the cantilever structure having at least one cable groove corresponding to the cable holder, and one bottom side of the groove facing the support pole; and
an upper lid disposed on the upper casing body, the upper lid having a release position and an open position relative to the casing body, wherein the upper lid is configured for moving from the open position to the fastening position, to push the cantilever structure to move towards the support pole, so as to reduce the distance from the bottom side of the cable groove to the support pole.

2. The connector according to claim 1, wherein the cantilever structure comprises a plate body and a projection, the plate body is connected to the casing body and has a first surface and a second surface opposite to each other; wherein the first surface faces the lower casing, and the second surface faces the upper lid; the projection is located on the second surface; the cable groove is formed by a recess of the first surface towards the projection, and has two ports oppositely located on two opposite sides of the projection.

3. The connector according to claim 1, wherein the base of the lower casing has a hole, corresponding to the cable groove, the cable groove being located between the hole and the cable holder.

4. The connector according to claim 1, wherein the base of the lower casing has a supporting surface, and when the upper lid is at the fastening position, the cantilever structure leans against the supporting surface.

5. The connector according to claim 4, wherein the supporting surface is inclined towards the support pole for 1 to 7 degrees.

6. The connector according to claim 5, wherein the supporting surface is inclined towards the support pole for 4.2 degrees.

7. The connector according to claim 1, wherein the cantilever structure has a first surface facing the lower casing, and an included angle is formed by the bottom side and the first surface, the included angle ranges from 25 to 35 degrees.

8. The connector according to claim 7, wherein the included angle is 30 degrees.

9. The connector according to claim 1, wherein the lower casing includes a first fastening element and a second fastening element located on the base, the upper casing includes a third fastening element located on the casing body, the upper lid includes a lid body and a fourth fastening element located on the lid body, the first fastening element are fastened with the third fastening element, and the second fastening element are fastened with the fourth fastening element.

10. The connector according to claim 1, wherein the upper lid is pivotally disposed on the casing body of the upper casing.
